(19) United States
(12) Patent Application Publication
(10) Pub. No.: US 2015/0022527 A1
(43) Pub. Date: Jan. 22, 2015

(54) Graph drawing techniques improving readabiity and aesthetics for high-degree nodes

(71) Applicant: Tom Sawyer Software, Berkeley, CA (US)

(72) Inventors: Brendan Madden, Berkeley, CA (US); Krists Boitmanis, Riga (LV)

(21) Appl. No.: 13/943,092

(22) Filed: Jul. 16, 2013

(51) Int. Cl. G06T 11/20

(52) U.S. Cl. CPC G06T 11/206
USPC 345/440

(57) ABSTRACT

A computer-implemented method is provided of drawing a graph in which nodes are connected by edges, with the edges having a specified minimum spacing. A shape or image representing a node is displayed, and a bounding box enclosing the node is determined, the bounding box being sized to satisfy the specified minimum spacing in relation to the bounding box. Outside the bounding box, placement of edges incident to the node is determined so as to satisfy the specified minimum spacing. Inside the bounding box, the edges are extended nearer to the image without requiring that the specified minimum spacing be observed, and the edges incident to the node are displayed.

### FIELD OF THE INVENTION

The present invention generally relates to graph drawing and data visualization.

### BACKGROUND OF THE INVENTION

In graphically rich presentations of relational data, nodes may be represented as combinations of images, text elements, shapes, and other graphical elements. When drawing lines (i.e., edges) between such nodes, a drawing system needs to determine the clipping points, i.e., where to terminate the lines at their end nodes. In the case of various graph drawing algorithms (for example, orthogonal graph drawing algorithms, directed graph drawing algorithms with orthogonal edge routing, independent orthogonal edge routing algorithms, etc.), it is typically assumed that the nodes are rectangular boxes and that there must be some minimum separation between parallel edge segments. An example of such a graph drawing is shown in FIG. 3.

Often times the node may not in fact be represented by a rectangular box, but may be represented by some other shape or by an image, as shown in FIG. 4, for example. One straightforward approach nevertheless terminates the lines at the bounding rectangle of the node, leaving a visual gap between the line and its end node as shown in FIG. 5A. Alternatively, in accordance with another approach, the lines are extended until they touch the shape of the node, as shown in FIG. 5B. The undesirable result, however, is that the lines cross each other.

Sometimes a node may be a high-degree node, meaning that it has many lines that connect to it, or in other words, many incident edges. If there is a minimum separation required between the parallel routed edges incident to such a node, the node is forced to grow in size. Various problems may result. For example, since the area of the node is a quadratic function of the degree of the node, the node becomes over-emphasized or overly conspicuous as a result of its large size. Also, if the graphical representation of the node contains a low-resolution image, scaling the image to fit the larger calculated node area may result in pixelation or other visually distracting results. An example of a graph drawing illustrating these problems is shown in FIG. 6.

In other instances, the node may not be allowed to be scaled. In various schematic applications, for example, users may impose very strict requirements in this regard, stemming from traditional industry hand-made or automatically-generated representations where the node may not change in size. Sometimes this size invariance is because the node reflects a strict physical property such as the size of a chip in a circuit, or a server in a wiring closet, or an element in an electrical schematic, or some other vertical market representation where time-honored practice or tradition guide the user's specification. Therefore, in some markets, the customers insist that the nodes must stay the fixed size that was specified.

Just as scaling the node may cause various undesirable results, the inability to scale the node because of user requirements may similarly lead to various undesirable results. For example, if the node degree is high, edges will need to be routed such that they violate the edge separation specification, as seen on the topside of the center node in FIG. 7. If there are labels positioned along the edges, the labels sometimes cannot be placed such that they do not overlap other edge segments, leading to drawings where it is not possible to make an unambiguous representation, as seen in FIG. 8. If edges are represented with varying widths, for example where the edge width represents a data attribute such as the importance or the speed or capacity of a link, then orthogonally routed edge segments will lay on top of each other at some point such that the drawing becomes ambiguous, as seen in FIG. 9. Finally, if along the border of the node, some edges attach to connectors that are placed at fixed distances less than the edge separation, then it is not possible to attach to these connectors without again violating the edge separation specification, as shown in FIG. 10.

### BRIEF DESCRIPTION OF THE DRAWING FIGURES

FIG. 1 is a block diagram of an information processing system.

FIG. 2 is a block diagram of a networked information processing system.

FIG. 3 is a diagram of an orthogonal graph drawing having specified minimum edge spacing.

FIG. 4 is a diagram of an orthogonal graph drawing in which a non-rectangular node is conceptualized by a rectangular bounding box.

FIG. 5A is a diagram of the orthogonal graph drawing of FIG. 4 with edges stopping at the bounding box, resulting in gaps.

FIG. 5B is a diagram of the orthogonal graph drawing of FIG. 4 with edges extended to touch the actual representation of the node, resulting in edge crossings.

FIG. 6 is a diagram of an orthogonal graph drawing in which a high-degree node represented by a graphical image is scaled up to satisfy minimum edge separation requirements.

FIG. 7 is a diagram of an orthogonal graph drawing in which the inability to scale a high-degree node results in the violation of minimum edge separation.

FIG. 8 is a diagram of an orthogonal graph drawing in which the inability to scale a high-degree node results in labeling ambiguities.

FIG. 9 is a diagram of an orthogonal graph drawing in which the inability to scale a high-degree node having edges of differing weights results in edge crowding or overlap.

FIG. 10 is a diagram of an orthogonal graph drawing in which the inability to scale a node having fixed edge connectors results in the violation of the minimum edge separation.

FIG. 11 is a flow diagram of a graph drawing technique resulting in improved readability and aesthetics for high-order nodes or constrained nodes.

FIG. 12 is a more detailed flow diagram of the method of FIG. 11.

FIG. 13 is a diagram of an intermediate graph representation.

FIG. 14 is a diagram of a final representation of the intermediate representation of FIG. 13.

FIG. 15 is a diagram of a graph drawn using the techniques described herein.

FIG. 16A is a diagram of another graph drawn using the techniques described herein.

FIG. 16B is a diagram of an alternative representation of the graph of FIG. 16A.

### DETAILED DESCRIPTION

Summary

In one aspect, a computer-implemented method is provided for drawing a graph in which nodes are connected by edges, with the edges having a specified minimum spacing. A shape or image representing a node is displayed, and a bounding box enclosing the node is determined, with the bounding box being sized to satisfy the specified minimum spacing in relation to the bounding box. Outside the bounding box, placement of edges incident to the node is determined so as to satisfy the specified minimum spacing. Inside the bounding box, the edges are extended nearer to the shape or image without requiring that the specified minimum spacing be observed, and the edges incident to the node are displayed.

In another aspect, a non-transitory computer-readable medium is provided for drawing a graph with multiple nodes connected by multiple edges, with computer instructions for displaying a shape or image representing a node and determining a bounding box enclosing the node, the bounding box being sized to satisfy the specified minimum spacing in relation to the bounding box. The computer instructions ensure that outside the bounding box, placement of edges incident to the node is determined so as to satisfy the specified minimum spacing. Inside the bounding box, the edges are extended nearer to the shape or image without requiring that the specified minimum spacing be observed, and the edges incident to the node are displayed.

Description

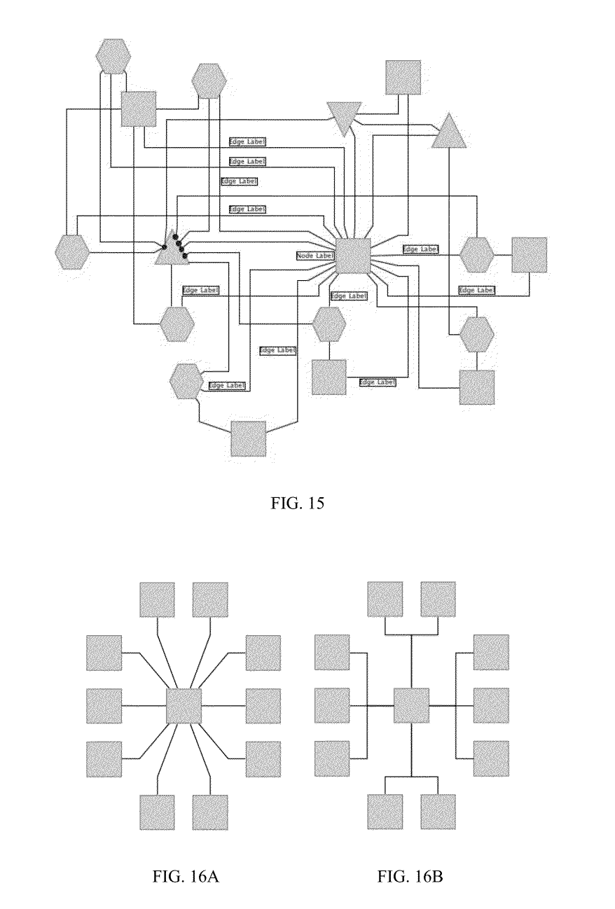

The subject of this patent application is techniques for routing connecting lines (edges)tograph nodes, especially high-order nodes or constrained nodes, for improved readability and aesthetic appearance. An example of a drawing using such an approach is shown in FIG. 15. Such techniques eliminate distraction and improve the appearance of the graph drawing.

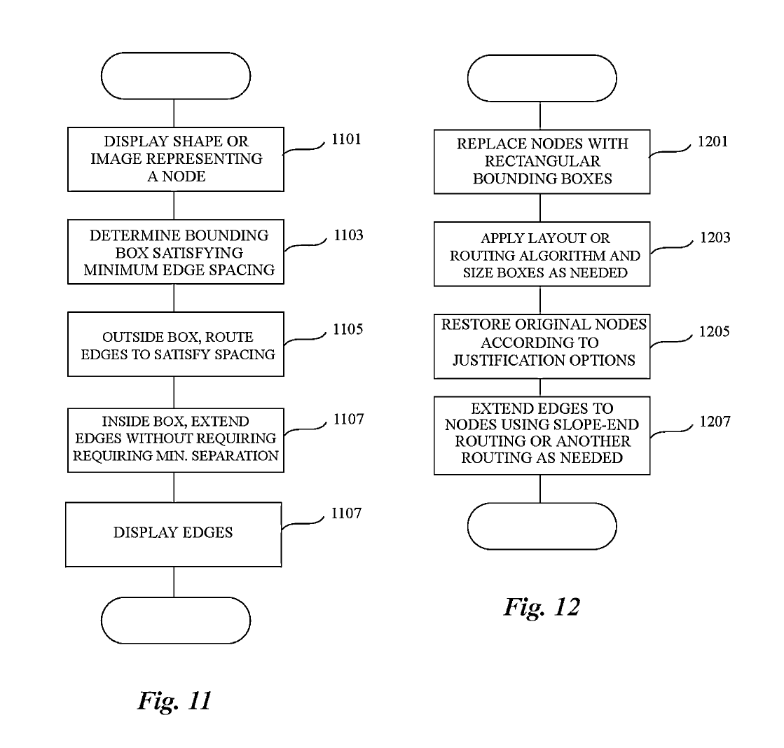

Referring to FIG. 11, a generalized flowchart is shown illustrating an example flow of a computer implemented method of drawing a graph with multiple nodes connected by multiple edges, using edge routing techniques especially suitable for graphs containing high-degree nodes or constrained nodes. At 1101, a shape or image is displayed representing a node. At 1103 a bounding box is determined that encloses the node, the bounding box being sized to satisfy a specified minimum spacing of edges incident to the node. At 1105, outside the bounding box, the placement of edges incident to the node is determined so as to satisfy the specified minimum spacing. At 1107, inside the bounding box, the edges are extended nearer the shape or image without requiring that the specified minimum spacing be observed. The edges are then displayed.

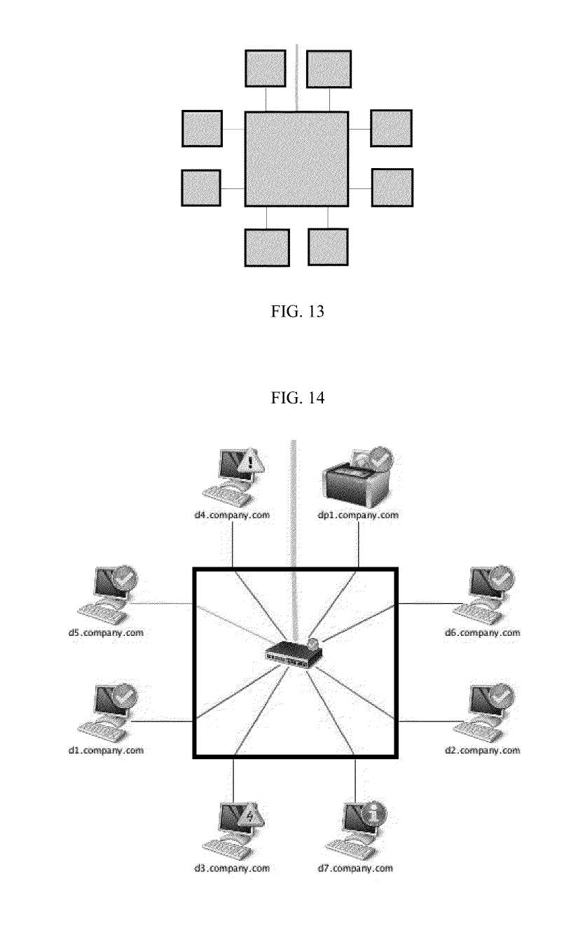

The flowchart of FIG. 12 illustrates one method for accomplishing the method of FIG. 11. At 1201, nodes are replaced with rectangular bounding boxes regardless of their originally specified shapes and images. These rectangular boxes will be at least as large in terms of width and height as the originally specified shapes and images. At 1203, a layout or routing algorithm is applied, and the nodes are sized as needed, for example to accommodate a specified minimum edge separation or to permit node, edge, or connector labels to be integrated into the graph drawing without overlaps. For example, the algorithm may be any schematic layout or routing algorithm that produces purely orthogonal drawings with no restriction on the size of the nodes. A resulting intermediate graph drawing representation is shown in FIG. 13.

At 1205, the original nodes are restored with their original shapes or images. In one embodiment, the originally specified size of the nodes is preserved with the nodes being placed such that their center points coincide with the center points of the respective rectangles. Alternatively, various justification options may be specified to alter the placement of the node shape or image within its bounding box. For example, an imagemight be placed at the center, top left, top right, bottom left, bottom right, or in other user-specified locations within the “cage” of the bounding box.

At 1207, the edges are extended between nodes, using slope routing as needed. In one embodiment, the first portion and the last portion of each edge are extended such that they touch the precise shapes of their respective end nodes, or such that they extend to a tight rectangle around the shape. This may not be possible for some nodes because the line containing the edge does not intersect with the shape of the node, or because a pair of edges would introduce a new crossing near the node. In this instance, slope routing may be used when orthogonally routed edges are joined with the actual node using a straight-line segment sloped towards the center point of the node. The resulting graph drawing obtained from the intermediate graph drawing of FIG. 13 is shown in FIG. 14.

There may be other suitable routings inside the box (or at the edge of the box) besides slope routings. For example, the edges that are attached to a node box from the same side can be merged to form fork-like structures, as seen in FIG. 16A and FIG. 16B.

To accommodate “level-of-detail” changes where the graphical attributes and badges drawn on a node change dynamically at different zoom levels, the drawing application can be made aware of exactly which edge segments need to be newly sloped or rerouted when a node shape and graphics change under these level-of-detail changes. For instance, the application may define for each of various zoom levels a minimum size of a variable-sized rectangle that satisfies the largest of the graphical shapes at that zoom level. In this way, routings outside of this larger minimum-sized “cage” may be preserved, producing better and more stable routings. These more stable routings help users preserve their mental map of the information they are viewing as the drawing needs to change at different zoom levels.

In accordance with the techniques described, “overly-constrained” or “no win” solutions are replaced with intermediate approaches where the user's specifications can in large part be met. When this technique is combined with the integrated labeling technology of the present assignee, it is possible to produce compact, highly readable, overlap-free, orthogonally-routed drawings in all areas of the drawing that are outside of variable-sized rectangles of those nodes that have been forced to grow in size. This technique allows the following seemingly conflicting requirements to be met: 1) a node can have an arbitrarily high degree; 2) an automated drawing system should respect the specified image shape and dimensions; 3) an automated drawing system should respect the minimum edge separation; 4) an automated drawing should try to place node, edge, and connector labels such that they are overlap-free; and 5) an automated drawing system can respect the edge separation and route to nodes that have irregularly-positioned connectors.

Without the techniques described, it is not possible to satisfy these requirements at the same time without overlaps, ambiguity, and readability problems in the area outside of the variable-sized intermediate rectangles. With the techniques described, it is possible to produce drawings that respect all five of the requirements mentioned above at the same time.

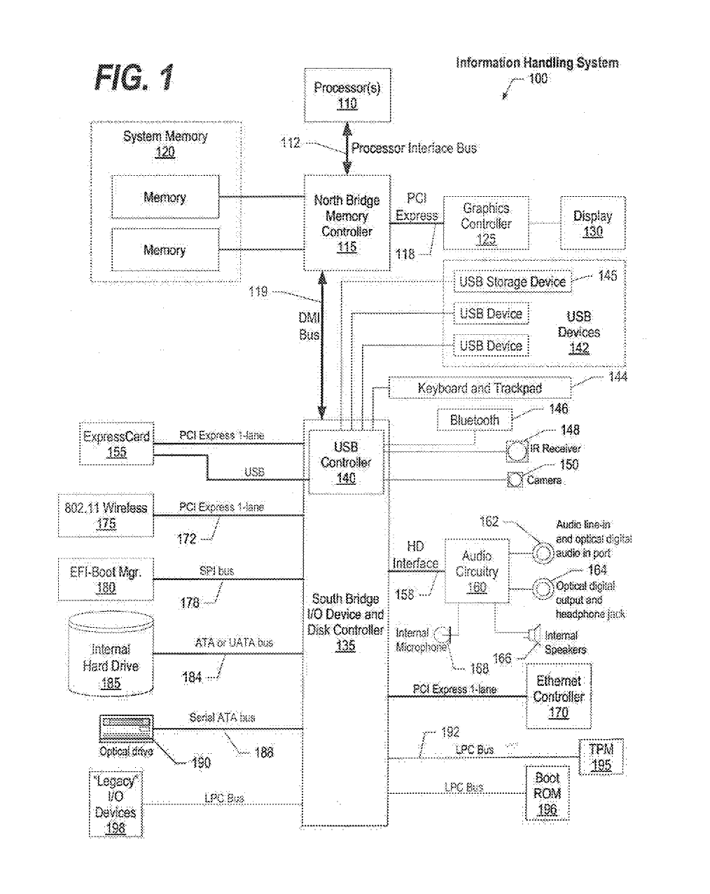

FIG. 1 illustrates information-handling system 100, which is a modified example of a computer system capable of performing the computing operations described herein. Information-handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge, Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” Chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172, LAN device 175 typically implements one of the IEEE 802.11 standards of over-the-air modulation techniques that all use the same protocol to wirelessly communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information-handling system 100 to a computer network, such as a Local Area Network (LAN), the Internet, and other public and private computer networks.

While FIG. 1 shows one information-handling system, an information-handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

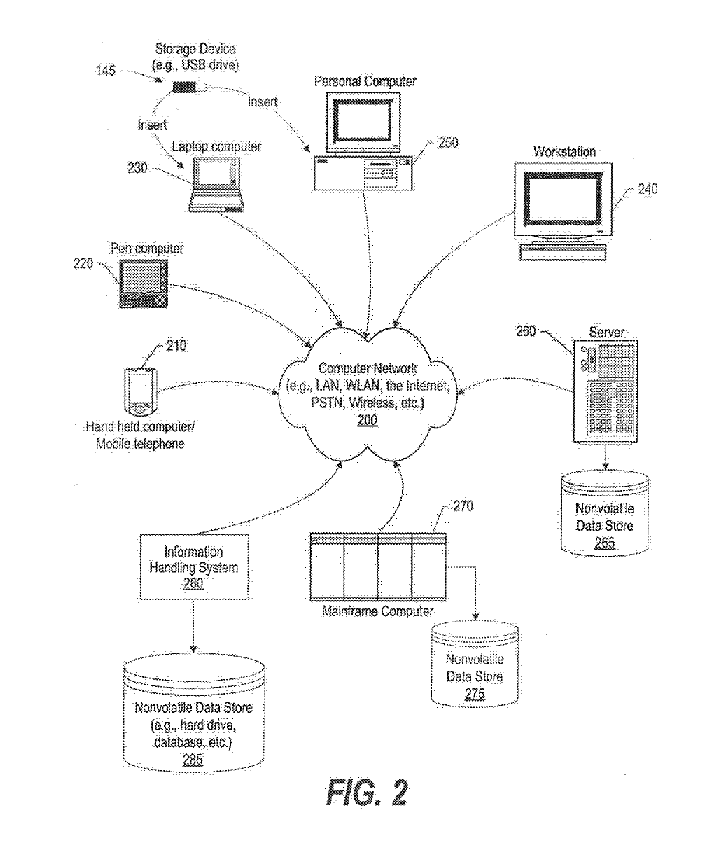

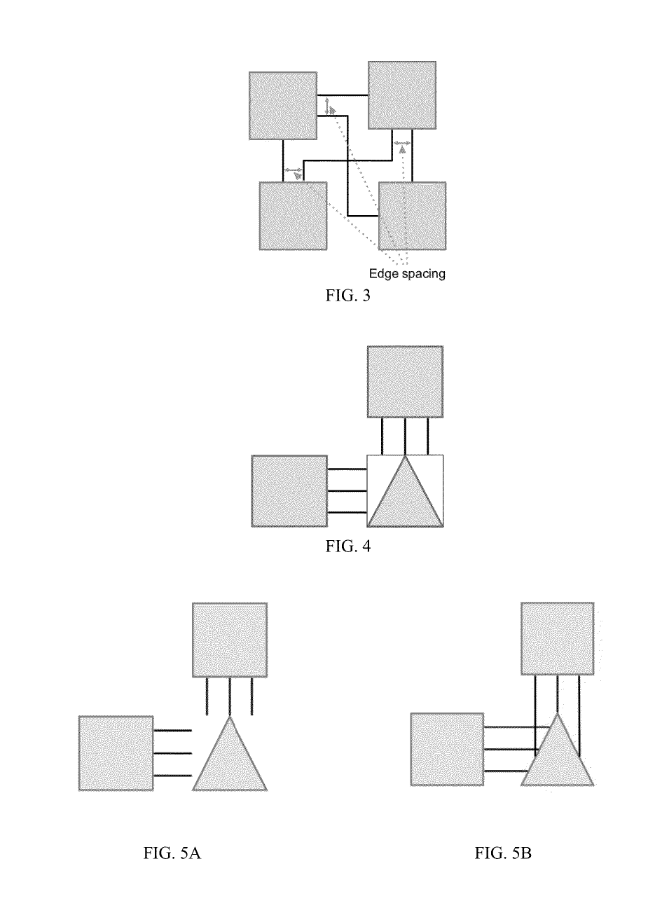

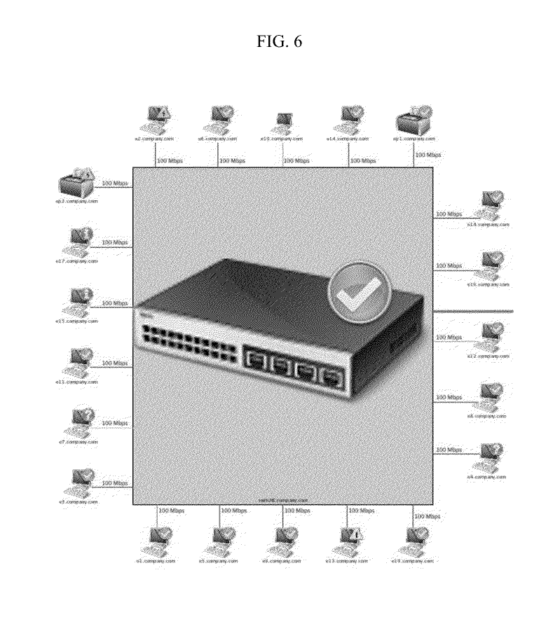

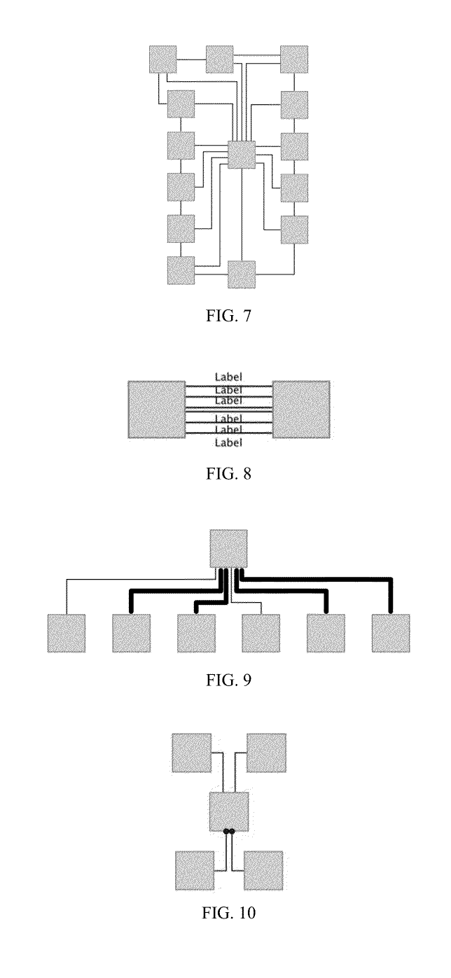

The Trusted Platform Module (TPM 195) shown in FIG. 1 and described herein to provide security functions is but one example of a hardware security module (HSM). Therefore, the TPM described and claimed herein includes any type of FISM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension example of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information-handling system 280. As shown, the various information-handling systems can be networked together using computer network 200. Types of computer networks that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information-handling systems. Many of the information-handling systems include nonvolatile data stores, such as hard drives and/or nonvolatile memory. Some of the information-handling systems shown in FIG. 2 depict separate nonvolatile data stores (server 260 utilizes nonvolatile data store 265, mainframe computer 270 utilizes nonvolatile data store 275, and information-handling system 280 utilizes nonvolatile data store 285). The nonvolatile data store can be a component that is external to the various information-handling systems or can be internal to one of the information-handling systems. In addition, removable nonvolatile storage device 145 can be shared among two or more information-handling systems using various techniques, such as connecting the removable nonvolatile storage device 145 to a USB port or other connector of the information-handling systems.

It will be appreciated by those skilled in the art that the present invention can be embodied in other specific forms without departing from the spirit or essential character thereof. The foregoing description is therefore intended in all respects to be illustrative and not restrictive. The scope of the invention is indicated by the appending claims, not the foregoing description, and all changes which come within the meaning and range of equivalents thereof are intended to be embraced therein.

What is claimed is:

1. A computer implemented method of drawing a graph comprising a plurality of nodes connected by a plurality of edges, the edges having a specified minimum spacing, the method comprising:
displaying a shape or image representing a node;
determining a bounding box enclosing the node, the bounding box being sized to satisfy the specified minimum spacing in relation to the bounding box;
outside the bounding box, determining placement of a plurality of edges incident to the node so as to satisfy the specified minimum spacing;
inside the bounding box, extending the plurality of edges nearer to the shape or image without requiring that the specified minimum spacing be observed; and
displaying the plurality of edges incident to the node.

2. The method of claim 1, wherein placement of the plurality of edges incident to the node is determined such that the plurality of edges incident to the node do not cross one another.

3. The method of claim 1, wherein placement of the plurality of edges incident to the node is determined to avoid gaps between different ones of the plurality of edges incident to the node and the image representing the node.

4. The method of claim 1, wherein sizing of the image is determined without dependence upon sizing of the bounding box.

5. The method of claim 1, wherein the plurality of edges incident to the node are displayed with different thicknesses representing different values of an attribute represented by the edges without violating the specified minimum spacing.

6. The method of claim 1, comprising of displaying respective labels, adjacent respective ones of the plurality of edges, incident to the node such that each label is unambiguously associated with a single edge by proximity to that edge.

7. The method of claim 1, wherein, outside the bounding box, the plurality of edges incident to the node are orthogonally-routed edges that extend in either a vertical direction or a horizontal direction.

8. The method of claim 1, wherein the image is centered within the bounding box.

9. The method of claim 1, wherein a center of the image is offset from a center of the bounding box in accordance with a specified justification option.

10. The method of claim 1, wherein inside the bounding box, the plurality of edges incident to the node connect to graphical elements representing connectors, the graphical elements representing the connectors being spaced apart in accordance with a spacing less than the specified minimum spacing.

11. The method of claim 1, wherein inside or at the bounding box, several edges from the plurality of edges incident to the node are joined together in order to produce a clearer, less cluttered routing.

12. A non-transitory computer-readable medium for drawing a graph comprising of a plurality of nodes connected by a plurality of edges, comprising instructions for:
displaying a shape or image representing a node;
determining a bounding box enclosing the node, the bounding box being sized to satisfy the specified minimum spacing in relation to the bounding box;
outside the bounding box, determining placement of a plurality of edges incident to the node so as to satisfy the specified minimum spacing;
inside the bounding box, extending the plurality of edges nearer to the shape or image without requiring that the specified minimum spacing be observed; and
displaying the plurality of edges incident to the node.

13. The apparatus of claim 11, wherein placement of the plurality of edges incident to the node is determined such that the plurality of edges incident to the node do not cross one another.

14. The apparatus of claim 11, wherein placement of the plurality of edges incident to the node is determined to avoid gaps between different ones of the plurality of edges incident to the node and the image representing the node.

15. The apparatus of claim 11, wherein sizing of the image is determined without dependence upon the sizing of the bounding box.

16. The apparatus of claim 11, wherein the plurality of edges incident to the node are displayed with different thicknesses representing different values of an attribute represented by the edges without violating the specified minimum spacing.

17. The apparatus of claim 11, comprising of displaying respective labels, adjacent respective ones of the plurality of edges, incident to the node such that each label is unambiguously associated with a single edge by proximity to that edge.

18. The apparatus of claim 11, comprising of displaying respective labels, adjacent respective ones of the plurality of edges, incident to the node such that each label is unambiguously associated with a single node by proximity to that node.

19. The apparatus of claim 11, comprising of displaying respective labels, adjacent respective ones of the plurality of edges, incident to the node such that each label is unambiguously associated with a single connector by proximity to that connector.

20. The apparatus of claim 11, wherein, outside the bounding box, the plurality of edges incident to the node are orthogonally-routed edges that extend in either a vertical direction or a horizontal direction.

21. The apparatus of claim 11, wherein the image is centered within the bounding box.

22. The apparatus of claim 11, wherein a center of the image is offset from a center of the bounding box in accordance with a specified justification option.

23. The apparatus of claim 11, wherein inside the bounding box, the plurality of edges incident to the node connect to graphical elements representing connectors, the graphical elements representing the connectors being spaced apart in accordance with a spacing less than the specified minimum spacing.

24. The apparatus of claim 11, wherein inside or at the bounding box, multiple ones of the plurality of edges incident to the node are joined together, allowing the multiple ones of the edges to be represented as a single edge.
